(19) United States
(12) Patent Application Publication
(10) Pub. No.: US 2016/0075102 A1
(43) Pub. Date: Mar. 17, 2016

(54) FIBER COMPOSITE COMPONENT WITH AN ELECTRICALLY CONDUCTIVE FIBER MATERIAL FOR REINFORCEMENT AS WELL AS A DEVICE FOR ITS MANUFACTURE

(71) Applicant: Airbus Operations GmbH, Hamburg (DE)

(72) Inventors: Mathias Jessrang, Hamburg (DE); Johannes Rehbein, Bremen (DE)

(73) Assignee: Airbus Operations GmbH, Hamburg (DE)

(21) Appl. No.: 14/851,028

(22) Filed: Sep. 11, 2015

(30) Foreign Application Priority Data
Sep. 15, 2014 (DE) 10 2014 113 279.3

(51) Int. Cl. B32B 5/26; D04H 1/44

(52) U.S. Cl. CPC B32B 5/26; D04H 1/44; B32B 2305/076; B32B 2307/202; B32B 2260/023; B32B 2260/046

(57) ABSTRACT

A fiber composite component as a structural component of an aircraft, encompasses a mat-shaped, electrically conductive fiber material embedded in several layers into a synthetic resin matrix, wherein individual fibers protrude as free fiber ends from the flat plane of the mat-shaped fiber material, so as to establish an electrical bridge connection between adjacent layers of the fiber material through an interspersed synthetic resin layer. A device for manufacturing such a fiber material is also described.

### FIELD OF THE INVENTION

The invention relates to a fiber composite component as a structural component of an aircraft, comprising a mat-shaped, electrically conductive material, which is embedded in several layers into a synthetic resin matrix. The invention further relates to a device for manufacturing the electrically conductive fiber material.

The area of application for the invention extends to aircraft construction. In particular structural components of an aircraft, for example of the fuselage and/or wing, can be made out of fiber composite materials. Predominantly used for this purpose are carbon fiber-reinforced plastics (CFK), in which carbon fibers are embedded in several layers into a plastic matrix as reinforcement. The matrix can here consist of thermosets or thermoplastics.

The manufacture of fiber composite components can take place using pre-impregnated fibers—so-called prepregs—consisting of carbon fibers and an uncured thermosetting plastic matrix, which are placed in a mold and cured under a pressure and temperature, preferably via autoclave pressing. By contrast, the electrically conductive fiber material formed according to the invention is normally processed into CFK components using the infusion or injection methods. After the dry fiber material has been saturated with resin in this way, the latter are cured. This can take place in a closed mold using the so-called RTM method, or in a one-sided mold using the vacuum infusion method.

The fiber material of a fiber composite of interest here can in principle take the form of mat-shaped laid webs, knitted fabrics, woven fabrics or nonwoven fabrics. Laid webs are nonwoven textile fabrics, whose fibers are laid parallel next to each other and fixed in position by knitting threads. Placing several fiber layers one on top of the other at different angles relative to each other results in a multiaxial textile laid web, for example, which as reinforcing fibers allows a fiber orientation that can handle loads within the framework of fiber composite components. A knitted fabric is a textile fabric fabricated out of a thread system via stitch formation, in which one fiber loop is slung into another. By contrast, a woven fabric is a generic term for manually or mechanically fabricated textile fabrics comprised of at least two thread systems crossing at a right angle or nearly a right angle, specifically warp and weft threads.

In addition, it is also possible to design a fiber material for use as a reinforcing insert in a fiber composite material as a nonwoven fabric. A nonwoven fabric is a textile structure consisting of fibers with a limited length, continuous filaments or cut yarns of any kind, which are in some way assembled into a mat-shaped fiber layer, and have in some way been bonded together.

The carbon fibers of a CFK component are electrically conductive. By contrast, the plastic matrix enveloping the latter acts as an electrical insulator. As a result, fiber composites fabricated out of the latter are electrically conductive in the direction of the surface extension; however, the most often several layers of carbon fiber mats with intermediate layers comprised of synthetic resin material interrupts electrical conductivity in the thickness direction. However, a sufficient electrical conductivity must also be generated in the thickness direction to protect the fiber composite of interest here against lightning.

### BACKGROUND OF THE INVENTION

Known from U.S. Pat. No. 6,749,012 B2 is a structural component for an aircraft, whose reinforcement consists of a textile nonwoven fabric, which to protect against lightning is interspersed in the thickness direction by a seam comprised of electrically conductive yarn introduced over the surface like a grid, for example a metallic thread. The electrically conductive yarn is preferably introduced into the component before the synthetic resin matrix has cured. In addition, an electrically nonconductive polymer thread can also be sewn.

While the electrically conductive grid-shaped network formed by the special seam does protect the structural component against lightning, the load-bearing capacity of a structural component made out of this reinforcement is rather limited. To elevate the load-bearing capacity, the component thickness must be increased, which would lead to an undesired rise in component weight.

DE 10 2007 075 491 B4 discloses a carbon fiber-reinforced structural component for aircraft construction, which can withstand relatively high mechanical loads due to a multi-ply structure of the reinforcement in conjunction with the resin matrix. The resin matrix also embeds carbon nanotubes, which ensure the generation of a high electrical conductivity to protect the structural component against lightning.

Further provided is a power source, which guides an electrical current into the structural component, heating the latter so as to realize a deicing, wherein a discharge device is provided to release the charge into the atmosphere, and the power source acts as an induction device. The integrated carbon nanotubes make it possible to discharge an electrical charge, in particular from a lightning strike, very quickly, while in the process avoiding spark formation.

WO 2011/114140 A1 discloses a method for manufacturing a fiber composite component, whose fiber material is processed as a prepreg. The prepreg encompasses a structural layer comprised of electrically conductive fibers and thermosetting synthetic resin in the gaps. An outer layer consisting of thermosetting synthetic resin is provided, and furnished with electrically conductive fibers at the interface between the structural layer and the outwardly located resin layer. In the cured state, this generates a hardened fiber composite that encompasses a hardened structural layer with conductive fibers packaged herein, and an outer layer consisting of hardened synthetic resin. A portion of the electrically conductive fibers projects into the outer layer comprised of hardened synthetic resin. This increases the electrical conductivity in the thickness direction of the fiber composite component. However, this technical solution is geared toward preimpregnated fiber material, i.e., prepregs.

### BRIEF SUMMARY OF THE INVENTION

It may be desirable to create an electrically conductive fiber composite part fabricated in an infusion or injection process that can be furnished with a reliable lightning protection in a technically simple manner.

An aspect of the invention includes the technical instruction that an electrically conductive fiber composite component encompasses several layers of a mat-shaped fiber material, which is embedded in a synthetic resin matrix, wherein free fiber ends that protrude at least from the flat plane of facing layers establish an electrical bridge connection between adjacent layers of the fiber material through the synthetic resin layer.

The electrically insulating synthetic resin layer is thereby electrically bridged between two adjacent layers in an advantageous manner, as a result of which the electrical conductivity is increased in the thickness direction of the fiber composite component without having to resort to prepreg fabrication for this purpose. This is because the solution according to the invention is suitable in particular for manufacturing fiber composite components in conventional infusion or injection processes. On the other hand, prepreg fabrication involves impregnating fiber matts with synthetic resin and guiding them between rollers so as to rigidify the latter. Free fiber ends that project from the flat plane of the impregnated fiber material are here pressed back into the fiber composite by the rollers. In contrast, the infusion or injection process involves moving the free fiber ends through the flow of synthetic resin during the molding process, thereby allowing them to establish electrical contact between adjacent layers of fiber material. As opposed to prepreg fabrication, then, manufacture does not take place with preimpregnated fiber material, but rather with dry fiber material having specially generated, free fiber ends that protrude from the flat plane to form the electrical contact fibers. The latter essentially remain in their protruding position while the synthetic resin is added. The ability to manufacture fiber composite components that are electrically conductive in the thickness direction makes it possible to fabricate fiber composite components having a comparatively higher static strength, wherein comparatively fewer free fiber ends are required to generate a sufficient electrical conductivity in this component.

In order to generate the free fiber ends protruding from the flat plane of the mat-shaped, dry fiber material, the material is transported in a dry state along a processing section via several rollers in a preferred embodiment of a device to be used for this purpose. The mat-shaped fiber material can alternately run over and under the rollers, wherein mechanical breaking devices, also denoted as breaking means, act on at least one location of the processing section on the surface of the fiber material to generate the free fiber ends on the surface of the fiber material.

For example, these mechanical breaking means can be designed like rollers with a rough or structured surface, which rotate at a different speed than the other transporting rollers of the device. As a result, the arising slippage roughens the surface of the fiber material, and individual fiber ends break out.

For example, the structured surface of the rollers provided as breaking means can be designed as needle-shaped or edge-shaped moldings onto their surface. As an alternative, the mechanical breaking means can also take the form of several sharp or blunt edge elements that scrape the surface of the fiber material during its transport along the processing section. Depending on the strength of the desired breaking effect and number of fiber ends to be generated, the cross section provided to these edge elements can be rectangular, rectangular with rounded edges, knifelike, or otherwise.

It is further possible to design the mechanical breaking means like a needle punch, whose individual needles pierce the mat-shaped fiber material in a transverse direction, so as to thereby generate free fiber ends on the side of the mat-shaped fiber material rearward of the puncture by breaking them out of the surface, and lift them away from the surface. This method roughly corresponds to a punching process, and several layers of fiber material can be processed at the same time. In particular when processing large portions of the layered structure of a component simultaneously, it may be best not to move the fiber material, but rather the punching tool.

The lightning-protected structural component of the airplane fabricated with such an electrically conductive fiber composite component can be produced in a manner known in the art, for example via autoclave curing in an oven. To this end, at least two layers of the fiber material are inserted into a component mold as an electrically conductive reinforcement of a fiber composite component, and then embedded and cured in synthetic resin as the matrix. However, the fiber material according to the invention is also suitable for use in other manufacturing processes for generating CFK components, for example through manual laminating, vacuum molding or the like.

### BRIEF DESCRIPTION OF THE DRAWINGS

Other measures that may improve upon the invention will be outlined in greater detail below based on the figures in conjunction with a description of an exemplary embodiment of the invention. Shown on:

FIG. 1 is a cross section through the fiber composite with free ends for establishing an electrical bridge connection between adjacent layers;

FIG. 2 is a schematic depiction of a first embodiment for a device for processing the mat-shaped fiber material to generate the free fiber ends;

FIG. 3 is a schematic depiction of a second embodiment for a device for processing the mat-shaped fiber material to generate the free fiber ends; and

FIG. 4 is a schematic depiction of a third embodiment for a device for processing the mat-shaped fiber material to generate the free fiber ends.

### DETAILED DESCRIPTION

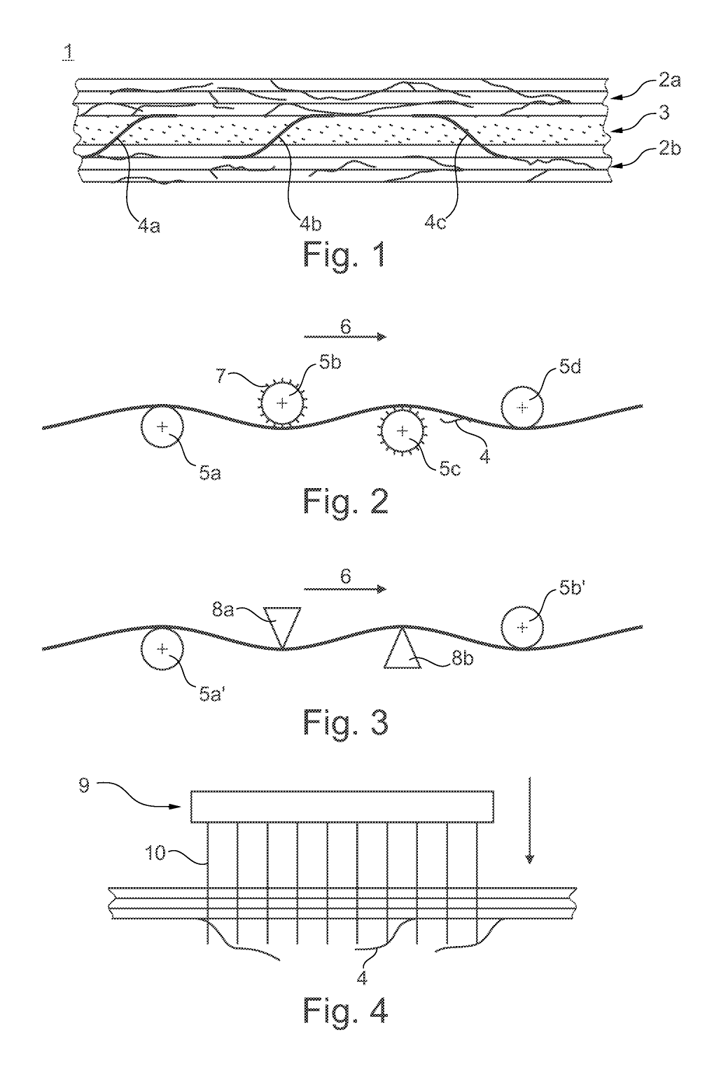

According to FIG. 1, a fiber composite component 1 depicted here in a cross sectional cutout as a structural component of an aircraft consists of two layers 2a and 2b made out of a mat-shaped fiber material, here a nonwoven material comprised of carbon fibers, which is embedded into a synthetic resin matrix. Situated between the two layers 2a and 2b of the fiber material is a synthetic resin layer 3. In order to establish an electrical bridge connection in the thickness direction of the fiber composite component 1, individual fibers protrude as free fiber ends 4a to 4c from the flat plane of the layers 2a, 2b of the mat-shaped fiber material, and come to abut against the surface of the opposing layer 2b or 2a.

In order to fabricate such a mat-shaped fiber material with superficially protruding free fiber ends, use can be made of a device according to FIG. 2, which transports the fiber material (bolded line) along a processing section 6 by means of several rollers 5a to 5d. Mechanical breaking means here act on the surface of the fiber material to generate free fiber ends 4 (as an example). The breaking means used here are two rollers 5b and 5c with a structured surface, which are driven at a different speed than the remaining—in this respect only transporting—rollers 5a and 5d. The resultant slippage causes the fibers to break open and generate free fiber ends 4. The structured surface of the rollers 5b and 5c is in this exemplary embodiment generated by needle-shaped moldings 7 on the cylindrical surface.

In the other exemplary embodiment of a device shown on FIG. 3 for manufacturing the inventive mat-shaped fiber material, the mechanical breaking means are designed as two sharp edge elements 8a and 8b. The edge elements 8a and 8b scrape into the surface of the mat-shaped fiber material, so that free fiber ends 4 come about. The fiber material is transported along the processing section 6 via two outer rollers 5a′ and 5b′ here as well.

In the additional exemplary embodiment of a device according to FIG. 4, the mechanical breaking means are designed as a needle punch 9, the individual needles 10 (as an example) of which pierce the mat-shaped fiber material in the transverse direction. As a result, free fiber ends 4 (as an example) are lifted away from the surface on the side of the mat-shaped fiber material lying opposite the needle punch 9.

The invention is not limited to the exemplary embodiment described above. Modifications thereto are instead also conceivable, and are also encompassed by the protective scope of the following claims. For example, it is also possible to combine more than two layers of the electrically conductive fiber material into a fiber composite component with lightning protection.

### REFERENCE LIST

1 Fiber composite component
2 Layer (of fiber material)
3 Synthetic resin layer
4 Free fiber end
5 Roller
6 Movement direction
7 Molding
8 Edge element
9 Needle punch
10 Needle

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A fiber composite component as a structural component of an aircraft, the component comprising:
a mat-shaped, electrically conductive fiber material embedded in several layers into a synthetic resin matrix, wherein individual fibers protrude as free fiber ends from the flat plane of the mat-shaped fiber material, so as to establish an electrical bridge connection between adjacent layers of the fiber material through an interspersed synthetic resin layer.

2. A device for manufacturing a mat-shaped fiber material for use in a fiber composite component of claim 1, comprising several rollers and mechanical breaking devices,
wherein the several rollers are configured to transport the mat-shaped fiber material along a processing section, and wherein the mechanical breaking devices act on the surface of the fiber material to generate the free fiber ends.

3. The device of claim 2, wherein the mechanical breaking devices are configured as rollers with a rough or structured surface rotating at a different speed than the remaining transporting rollers.

4. The device of claim 3, wherein needle-shaped or edge-shaped moldings are arranged on the surface of the rollers to generate their structured surface.

5. The device of claim 2, wherein the mechanical breaking devices are configured as several sharp or blunt edge elements.

6. The device of claim 5, wherein the edge elements are configured with a knifelike edge, rounded edge or rectangular edge.

7. The device of claim 2, wherein the mechanical breaking devices are configured as a needle punch, whose needles pierce the mat-shaped fiber material in a transverse direction, so as to lift the free fiber ends that were broken out as a result away from the surface of the fiber material.

8. The device of claim 7, wherein the needle punch is configured to move over the resting fiber material, which partially or completely encompasses the layer structure of a fiber composite component.

9. A structural component of an aircraft, the structural component comprising an electrically conductive fiber composite component comprising:
a mat-shaped, electrically conductive fiber material embedded in several layers into a synthetic resin matrix, wherein individual fibers protrude as free fiber ends from the flat plane of the mat-shaped fiber material, so as to establish an electrical bridge connection between adjacent layers of the fiber material through an interspersed synthetic resin layer.
